(19) United States
(12) Patent Application Publication
(10) Pub. No.: US 2010/0141063 A1
(43) Pub. Date: Jun. 10, 2010

(54) Cooling frame for electric motors

(76) Inventors: JonYeon Oh, Fort Wayne, IN (US); Michael L. Jones, Fort Wayne, IN (US); Tarun Sharma, Bhopal (IN); Shanmugam Venkatachalam Ravi, Tamil Nadu (IN)

Correspondence Address: General Electric Company;GE Global Patent Operation, 2 Corporate Drive, Suite 648, Shelton, CT, 06484, US

(21) Appl. No.: 12/330,826

(22) Filed: Dec. 9, 2008

(51) Int. Cl. H02K 9/06

(52) U.S. Cl. 310/62

(57) ABSTRACT

A housing for an electric motor, the housing including a substantially cylindrical shaped frame having a first and second opposing ends and a longitudinal axis running between the first and second opposing ends, and a plurality of air flow outlets each having a longitudinal axis, the plurality of air flow outlets being radially disposed about a circumference of the frame such that the longitudinal axis of each of the plurality of air flow outlets is located in a plane that is substantially orthogonal to the longitudinal axis of the frame.

### BACKGROUND

1. Field

The subject matter described herein relates generally to electric motors and, more particularly, to cooling one or more components of the electric motor.

2. Related Art

Electric motors generally generate heat during operation as a result of both electrical and mechanical losses, and an electric motor typically must be cooled in order to ensure the desired and efficient operation of the motor. An excessively high motor temperature may result in motor bearing failure or damage to the stator winding insulation.

Electric motors generally have an enclosure, or housing, including a frame and endshields. The most common enclosures are “open” or totally closed. Referring to FIG. 1, with an open enclosure, ambient air enters the housing through air flow inlets and circulates within the enclosure, and heat is removed by convection between the air and heat generating motor components within the housing. The air is exhausted out from the housing through air flow outlets. The air flow outlets are generally axially oriented elongated slots that have a longitudinal axis running parallel with the longitudinal axis L of the motor. The axially oriented air flow outlets may limit the air flow through the motor. The axially oriented air flow outlets may also increase the length of the motor. For example, where the air flow outlets are axially oriented such as in the motor of FIG. 1 a length of the motor housing has to be configured to accept a length of the axially oriented slots.

It would be desirable to provide an electric motor having a decreased length and a cooling system that allows an increased flow of cooling air to circulate through and flow out of the motor.

### BRIEF DESCRIPTION OF THE EMBODIMENTS

In accordance with one exemplary embodiment, a housing for an electric motor is provided. The housing includes a substantially cylindrical shaped frame having a first and second opposing ends and a longitudinal axis running between the first and second opposing ends, and a plurality of air flow outlets each having a longitudinal axis, the plurality of air flow outlets being radially disposed about a circumference of the frame such that the longitudinal axis of each of the plurality of air flow outlets is located in a plane that is substantially orthogonal to the longitudinal axis of the frame.

In accordance with another exemplary embodiment, an electric motor is provided. The electric motor includes a rotor having one or more fins, a stator having windings, the stator being disposed relative to the rotor for causing rotation of the rotor about an axis of the electric motor, and a housing being configured to house the rotor and stator, the housing including one or more air flow outlets radially disposed about a circumference of the housing, each of the air flow outlets having a longitudinal axis disposed in a plane that is substantially orthogonal to the axis of the electric motor.

In accordance with yet another exemplary embodiment, an electric motor is provided. The electric motor includes a housing having air flow inlets and air flow outlets, the air flow inlets and air flow outlets being configured to effect a cooling of the electric motor, and a stator disposed within the housing, where the air flow outlets are positioned a predetermined distance relative to an edge of the stator.

### BRIEF DESCRIPTION OF THE DRAWINGS

The following detailed description is made with reference to the accompanying drawings, in which:

FIG. 1 is schematic illustration of a conventional motor;

FIG. 2 is a schematic illustration of a motor in accordance with an exemplary embodiment;

FIG. 3A is a schematic illustration of a portion of the motor of FIG. 2;

FIG. 3B is a schematic side view of the motor of FIG. 2 in accordance with an exemplary embodiment;

FIGS. 4 and 5 are schematic illustrations of portions of the motor of FIG. 2 in accordance with an exemplary embodiment;

FIG. 6 is a chart illustrating air flow rates of a motor in accordance with an exemplary embodiment;

FIGS. 7A-7C are respectively schematic illustrations of a vent configuration, temperature distribution and air flow rate distribution for a portion of a conventional motor;

FIGS. 8A-8C are respectively schematic illustrations of a vent configuration, temperature distribution and air flow rate distribution for a portion of the motor of FIG. 2 in accordance with an exemplary embodiment; and

FIGS. 9A-9C are respectively schematic illustrations of a vent configuration, temperature distribution and air flow rate distribution for a motor in accordance with an exemplary embodiment.

### DETAILED DESCRIPTION OF THE PREFERRED EMBODIMENTS

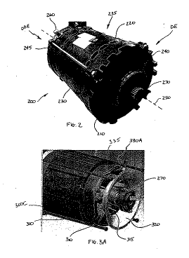

In one exemplary embodiment, referring to FIGS. 2 and 3, an electric motor 200 is provided. Although the embodiments disclosed will be described with reference to the drawings, it should be understood that the embodiments disclosed can be embodied in many alternate forms. In addition, any suitable size, shape or type of elements or materials could be used.

The disclosed embodiments provide for increasing the flow of air through an electric motor to reduce an operating temperature of the motor. The disclosed embodiments also provide for decreasing a length of the electric motor while providing adequate cooling air flow through the electric motor for reducing the operating temperature of the motor.

In accordance with an exemplary embodiment, the motor 200 includes a motor housing 235, a stator 300 and a rotor 310. The motor housing 235 includes an elongated substantially cylindrical shaped frame 230 having and two endshields 240, 245 where each endshield is disposed at and attached to a respective end of the frame 230. One or more of the endshields 240, 245 may include any suitable number of air flow inlets 210 for allowing ambient air to enter the housing 235. The air flow inlets 210 may have any suitable shape and size. The frame 230 may include one or more air flow outlets 220, as will be described in greater detail below, for allowing air to exit the housing 230.

The stator 300 may be supported within the motor housing 235 by, for example, the frame 230 in any suitable manner and include for example, a stator winding core 300C and stator windings 335. Power may be supplied to the stator 300 in any suitable manner, such as through one or more power terminals 260. The power terminals 260 may be mounted to the frame 230 and connected to the stator 300 in any suitable manner. The rotor 310 may be supported within the housing 235 by for example, suitable bearings disposed in, for example, the endshields 240, 245 or any other suitable supports located within the housing 235. The rotor 310 may include a drive shaft 270 and fins 315. In one exemplary embodiment, the drive shaft 270 may be integrally formed with the rotor 310 in a unitary one-piece construction. In alternate embodiments the drive shaft may be coupled with the rotor in any suitable manner. The drive shaft 270 may protrude through one or more endshields 240, 245. For example, in this exemplary embodiment the drive shaft 270 may protrude through endshield 240 at a drive end DE of the motor 200. The fins 315 may extend from the rotor 310 and be configured to, for example, draw ambient air into the housing 235 through air flow inlets 210 and direct heated air out of the housing 235 through air flow outlets 220. In alternate embodiments the flow of air through the housing may be effected in any suitable manner.

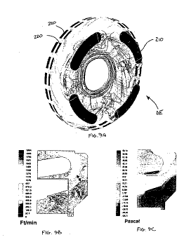

Still referring to FIG. 2 and also to FIG. 3B, the air flow outlets 220 will be described in accordance with an exemplary embodiment. The air flow outlets 220 may have any suitable shape and/or size. For exemplary purposes only, the air flow outlets 220 are shown as elongated slots having a width W and a length SL. Each of the air flow outlets 220 has a longitudinal axis running the length SL of each of the slots. In accordance with the exemplary embodiment, the longitudinal axis of each air flow outlet 220 is oriented in a radial direction with respect to a longitudinal axis 250 of the motor 200 (e.g. an axis of the motor running between a drive end DE of the motor and an end ODE opposite the drive end DE). For example, referring to FIG. 3B, the longitudinal axis 220A of each of the air flow outlets 220 is oriented such that the longitudinal axis 220A is located in a plane substantially orthogonal to the longitudinal axis 250 of the motor 200. In this example, any suitable number of air flow outlets 220 may be radially disposed, in for example one or more rows, located around a circumference of the frame 230. It is noted that the one or more rows of air flow outlets 220 may be located adjacent each other (See e.g. FIG. 9A). Here there is one row of air flow outlets 220 located adjacent each end of the motor. In other exemplary embodiments, there may be any number of rows of air flow outlets adjacent each end of the motor. In alternate embodiments, the air flow outlets may only be located on one end of the motor. The air flow outlets 220 may be located any suitable predetermined distance X from, for example, one or more edges of the stator winding core 300C. The edges of the stator winding core 300C are illustrated as dashed lines 330A, 330B in FIG. 3B. FIG. 3B also illlustrates the stator windings 335 as dashed lines. It is noted that while, in this exemplary embodiment, the air vent outlets 220 at a drive end DE of the motor 200 and at an end ODE opposite the drive end are shown as being substantially the same distance X from a respective edge of the stator winding core 300C, in alternate embodiments, the respective distances between a respective edge of the stator winding core 300C and the air vent outlets at the drive end DE and the air vent outlets at the end ODE opposite the drive end may be different from each other.

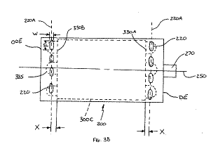

Referring again to FIGS. 2 and 3A as well as to FIGS. 4 and 5, a baffle 320 having an inlet 321 and an outlet 322 may be disposed within the housing 235 at least partly between the air flow inlets 210 and the fins 315 of the rotor for guiding a flow of air into the housing 235 and over the components of the motor 200 (FIG. 2). In accordance with an exemplary embodiment the baffle is located on the drive end DE (FIG. 2) of the motor 200 but in alternate embodiments a baffle may be located on both ends of the motor or at the end of the motor located opposite the drive end (e.g. end ODE in FIG. 2). The baffle 320 may have any suitable shape and/or size for guiding the flow of air into the housing 235. In alternate embodiments, the air flowing into the motor may be guided within the housing in any suitable manner. The baffle 320 may be radially disposed relative to, for example, an outside diameter of the fins 315 (or any other suitable feature of the fins) in any suitable manner. For example, in one exemplary embodiment, the baffle 320 may be located in a first position 320A relative to the fins 315 such that an outlet aperture 320AI of the baffle is disposed radially outward of the outside diameter of the fins 315. In another exemplary embodiment, the baffle 320 may be located in second position 320B relative to the fins 315 such that an outlet aperture 320BI of the baffle is disposed substantially at the outside diameter of the fins 315. In still another exemplary embodiment, the baffle 320 may be located in a third position 320C relative to the fins 315 such that an outlet aperture 320CI of the baffle is disposed radially inward of the outside diameter of the fins 315. In alternate embodiments the outlet aperture (or any other portion) of the baffle may have any suitable positional relationship relative to the fins. In accordance with an exemplary embodiment, the baffle 320 may also be axially disposed from tips of the fins 315 by any suitable predetermined distance D (e.g. the tip clearance).

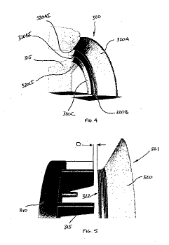

FIG. 6 is a chart that illustrates, for exemplary purposes only, air flow rates of the motor 200 (FIG. 2) in accordance with an exemplary embodiment with the baffle 320 located at, for example, positions 320A, 320B and 320C (FIG. 4). As can be seen in FIG. 6 the exemplary air flow rates have units of measure in cubic feet per minute (CFM) for various exemplary values of the distance D between the tips of the fins 315 and the baffle 320 and various values of the predetermined distance X (FIG. 3B) between the longitudinal axis of the air flow outlets 220 and the edge of the stator 330A, 330B. In the exemplary embodiments, the distance D (e.g. tip clearance; FIG. 5) ranges from about 0.1 to about 0.45 inches (e.g. 0.5 inches) and the distance X ranges from about 0.0 to about 0.5 inches. In alternate embodiments, the distances D, X may be any suitable distances. In one exemplary embodiment the distances D, X may be fixed at a predetermined value while in alternate embodiments the baffle, fins and/or air flow outlets may be adjustable so that the distances D, X are selectively variable. The air flow rates through the motor 200 with the baffle 320 in, for example, the first position 320A may range from about 43.63 to about 45.12 CFM at the drive end DE with an air flow rate of about 52.4 CFM at the end ODE opposite the drive end. The air flow rates through the motor 200 with the baffle 320 in, for example, the second position 320B may range from about 36.61 to about 37.03 CFM at the drive end DE with an air flow rate of about 45.6 CFM at the end ODE opposite the drive end. The air flow rates through the motor 200 with the baffle 320 in, for example, the third position 320C may range from about 32.01 to about 32.7 CFM at the drive end DE with an air flow rate of about 40.5 CFM at the end ODE opposite the drive end.

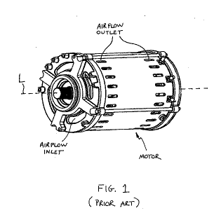

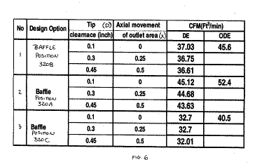

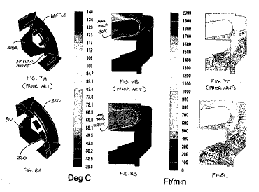

FIGS. 7A-7C and 8A-8C illustrate an exemplary comparison of operating temperature and air flow rates through, for example, the conventional motor of FIG. 1 and a motor 200 (FIG. 2) in accordance with an exemplary embodiment. For exemplary purposes, the maximum operating temperature of the conventional motor is about 130° C. while the maximum operating temperature of the motor 200 is about 121° C. Also for exemplary purposes, the air flow rate through the conventional motor is about 37.03 CFM while the air flow rate through the motor 200 is about 48.7 CFM.

FIGS. 9A-9C illustrate exemplary air flow rates and pressures for a motor, such as motor 200 (FIG. 2) in accordance with an exemplary embodiment. In this exemplary embodiment the motor 200 may have two adjacent rows of radially oriented air flow outlets 220 disposed at an end, such as the drive end DE, of the motor 200. In this exemplary embodiment the flow rate of air through the motor is about 48.12 CFM.

It should be understood that the air flow rates may be adjusted in accordance with the exemplary embodiments by adding or removing radially oriented air flow outlets to/from the frame 230 (FIG. 2) and/or by increasing or decreasing a size of the air flow outlets. The location of the radially oriented air flow outlets relative to, for example, the ends of the stator may also be adjusted for controlling the air flow rates through the motor in accordance with an exemplary embodiment.

The radially oriented air flow outlets of the exemplary embodiments provide for a motor having a reduced length. The radially oriented air flow outlets also provide additional surface area on the frame of the motor for attaching the motor power terminals without sacrificing a number of air flow outlets. The exemplary embodiments may also provide an increased air flow through the motor for reducing, for example, the operating temperature of the motor.

While exemplary embodiments have been described in connection with what are presently considered to be the most practical and preferred embodiments, it is to be understood that the embodiments are not limited to those disclosed herein. Rather, the embodiments described are intended to cover all of the various modifications and equivalent arrangements included within the spirit and scope of the appended claims.

What is claimed is:

1. A housing for an electric motor, the housing comprising:
a substantially cylindrical shaped frame having a first and second opposing ends and a longitudinal axis running between the first and second opposing ends; and
a plurality of air flow outlets each having a longitudinal axis, the plurality of air flow outlets being radially disposed about a circumference of the frame such that the longitudinal axis of each of the plurality of air flow outlets is located in a plane that is substantially orthogonal to the longitudinal axis of the frame.

2. The housing of claim 1, wherein a stator is disposed within the housing, the plurality of air flow outlets being positioned a predetermined distance relative to an end of the stator for effecting a cooling down of the motor.

3. The housing of claim 1, wherein the plurality of air flow outlets are arranged in one or more circumferential rows of air flow outlets.

4. The housing of claim 3, wherein the one or more rows of air flow outlets are disposed adjacent one or more of the first and second opposing ends of the frame.

5. An electric motor comprising:
a rotor having one or more fins;
a stator having windings, the stator being disposed relative to the rotor for causing rotation of the rotor about an axis of the electric motor; and
a housing being configured to house the rotor and stator, the housing including one or more air flow outlets radially disposed about a circumference of the housing, each of the air flow outlets having a longitudinal axis disposed in a plane that is substantially orthogonal to the axis of the electric motor.

6. The electric motor of claim 5, wherein the one or more air flow outlets are positioned a predetermined distance relative to an end of the stator for effecting a cooling down of the motor.

7. The electric motor of claim 5, wherein the predetermined distance is from about 0.0 inches to about 0.5 inches.

8. The electric motor of claim 5, wherein the one or more air flow outlets are arranged in one or more rows of air flow outlets.

9. The electric motor of claim 5, where the housing includes a first and second opposing ends, the electric motor further comprising:
an end shield located at each of the first and second ends, at least one end shield including one or more air flow inlets; and
a baffle disposed adjacent the air flow inlet, wherein the one or more fins are configured to cause a passage of air from the one or more air flow inlets through the baffle and into the housing.

10. The electric motor of claim 9, wherein the baffle includes an inlet and an outlet, the baffle being disposed relative to the fins such that the outlet of the baffle is located radially outward of an outside diameter of the fins.

11. The electric motor of claim 9, wherein the baffle includes an inlet and an outlet, the baffle being disposed relative to the fins such that the outlet of the baffle is located substantially at an outside diameter of the fins.

12. The electric motor of claim 9, wherein the baffle includes an inlet and an outlet, the baffle being disposed relative to the fins such that the outlet of the baffle is located radially inward of an outside diameter of the fins.

13. The electric motor of claim 9, wherein an outlet of the baffle is axially positioned a predetermined distance from the fins.

14. The electric motor of claim 13, wherein the predetermined distance is from about 0.1 inches to about 0.5 inches.

15. An electric motor comprising:
a housing having air flow inlets and air flow outlets, the air flow inlets and air flow outlets being configured to effect a cooling of the electric motor; and
a stator disposed within the housing, where the air flow outlets are positioned a predetermined distance relative to an edge of the stator.

16. The electric motor of claim 15, wherein the predetermined distance is a distance between a radially oriented longitudinal axis of the air flow outlets and the edge of the stator.

17. The electric motor of claim 15, wherein the predetermined distance is from about 0.0 inches to about 0.5 inches.

18. The electric motor of claim 15, wherein the air flow outlets comprise elongated slots radially disposed about a circumference of the housing, a length of each of the elongated slots running in a circumferential direction about the housing.

19. The electric motor of claim 15, wherein the air flow outlets are arranged in adjacent rows of air flow outlets.

20. The electric motor of claim 15, further comprising:
a rotor disposed within the housing, the rotor having fins configured to cause a flow of air through the housing; and
a baffle disposed within the housing and adjacent the air flow inlets, the baffle including a baffle inlet and a baffle outlet, the baffle being disposed relative to the fins such that the outlet of the baffle is located radially outward of an outside diameter of the fins, substantially at the outside diameter of the fins, or radially inward of the outside diameter of the fins.
